(19) United States
(12) Patent Application Publication
(10) Pub. No.: US 2012/0185173 A1
(43) Pub. Date: Jul. 19, 2012

(54) NEURAL ACTIVITY MEASUREMENT SYSTEM

(75) Inventors: Tsuyoshi YAMAMOTO, Kawagoe (JP); Hideaki KOIZUMI, Tokyo (JP); Tomihiro HASHIZUME, Hatoyama (JP); Seiji HEIKE, Kawagoe (JP)

(73) Assignee: Hitachi, Ltd.

(21) Appl. No.: 13/345,785

(22) Filed: Jan. 9, 2012

(30) Foreign Application Priority Data
Jan. 13, 2011 (JP) 2011-004460

(51) Int. Cl. G06F 19/00

(52) U.S. Cl. 702/19

(57) ABSTRACT

The present invention provides a neural activity measurement system for measuring the electrical response of a neuron itself to achieve an electrical measurement of the neural activity itself, by providing a stimulator for applying an electrical stimulus to the neuron, as well as a Kelvin probe including a cantilever for detecting the electrical signal propagated through the neuron.

### CLAIM OF PRIORITY

The present application claims priority from Japanese patent application JP2011-004460 filed on Jan. 13, 2011, the content of which is hereby incorporated by reference into this application.

### BACKGROUND OF THE INVENTION

1. Field of the Invention

The present invention relates to a method and system for measuring the activity of a biological neuron.

2. Description of the Related Art

In the related art, for example, Non-patent document 1 (“Mental Illness and NIRS” written by Masato Fukuda, Nakayama Shoten Co., pp. 79-102) discloses a method for measuring the brain activity of a patient suffering from a mental illness by near infrared spectrometry to identify the mental illness according to the obtained waveform. In this method, a light irradiation probe and a light detection probe are placed on the skin represented by the head of a subject. Then, a question task is presented to the subject to calculate the change in the blood volume, by calculating the change in the intensity of the light passing through the biological tissue during the period corresponding to the time of the task, based on the intensities of the light passing through the biological tissue before and after the task is run. The change in the blood volume is shown as a time waveform with a temporal resolution of about 100 ms. At this time, it is possible to measure changes in both oxygenated hemoglobin and deoxygenated hemoglobin simultaneously by irradiating the sample with light of plural wavelengths.

By comparing the waveforms with respect to each illness group, it is possible to identify healthy subject group, schizophrenia group, bipolar disorder group, and depression group. Thus, it is possible to estimate the mental state of the subject at that time.

This measurement method can be applied not only to diseased subjects but also to healthy subjects. Further, it is also possible to track the state of relief from illness by taking medication. Thus, the measurement method can be used in a wide range of applications.

Meanwhile, if it is possible to detect the probability of a child being affected by a disease earlier, namely, immediately after birth, then proper care can be provided to the child at an early stage and the effect is high.

In recent years, the approach for observing biological samples by a scanning probe microscope (hereinafter also referred to as SPM) has been developed.

The scanning probe microscope can obtain both physical properties and shape simultaneously by using a metal probe, allowing easy analysis of the relationship between shape and physicality with a high spatial resolution.

With respect to the SPM in related arts, Patent document 1 (Japanese Patent Application Laid-Open Publication No. 2008-79608) discloses a technology for analyzing the function of a cell by measuring the change in the potential in the cell in response to an external stimulus (physical or chemical stimulus). Further, Patent document 2 (Japanese Patent Application Laid-Open Publication No. 2008-539697) discloses a technology for providing drug screening or diagnosis by applying an external stimulus such as biochemical reaction to a cell sample (cultured cell, nerve cell) including a cancer cell, and measuring the characteristics of the cell by a mutation or other abnormality in the cell membrane as the response to the stimulus, by using an atomic force microscope (AFM).

Further, a recent study has focused on the function or other characteristics of a cultured neuron collected from a patient affected by Rett syndrome (Non-patent document 2: A Model for Neural Development and Treatment of Rett Syndrome Using Human Induced Pluripotent Stem Cells, Maria C. N. Marchetto et al. Cell 143, pp. 527-539).

### SUMMARY OF THE INVENTION

However, in the brain function measurement using near infrared light described above, there is no report on the method for detecting the state of mental illness of subjects immediately after birth at an early stage. Because of its nature, it is difficult to evaluate the neural activity at the cell level.

Further, also in the measurement using SPM, a technology that addresses the neuron itself as a measurement target has not been yet established, including the measurement method.

Accordingly, an object of the present invention is to provide a system for measuring the response of the neuron itself (electrical response), instead of the response of the general cell or cell membrane itself, to achieve electrical measurement of the neural activity itself, allowing prediction and diagnosis of neuron disorders.

In light of the fact that a voltage is generated in neural transmission, the present invention provides a stimulator for applying an electrical stimulus to a neuron, and a Kelvin probe including a cantilever for detecting the electrical signal propagated through the neuron.

The measurement of the neural activity at the cell level may allow diagnosis of mental illness derived from neural activity, as well as prediction of a future development of mental illness.

Further, this measurement method can provide an easy way to measure the neural activity, independent of the state of the subject.

### BRIEF DESCRIPTION OF THE DRAWINGS

FIG. 1 is a block diagram of the entire system; and

FIG. 2 is a view of an example of the measurement.

### DETAILED DESCRIPTION OF THE INVENTION

### First Embodiment

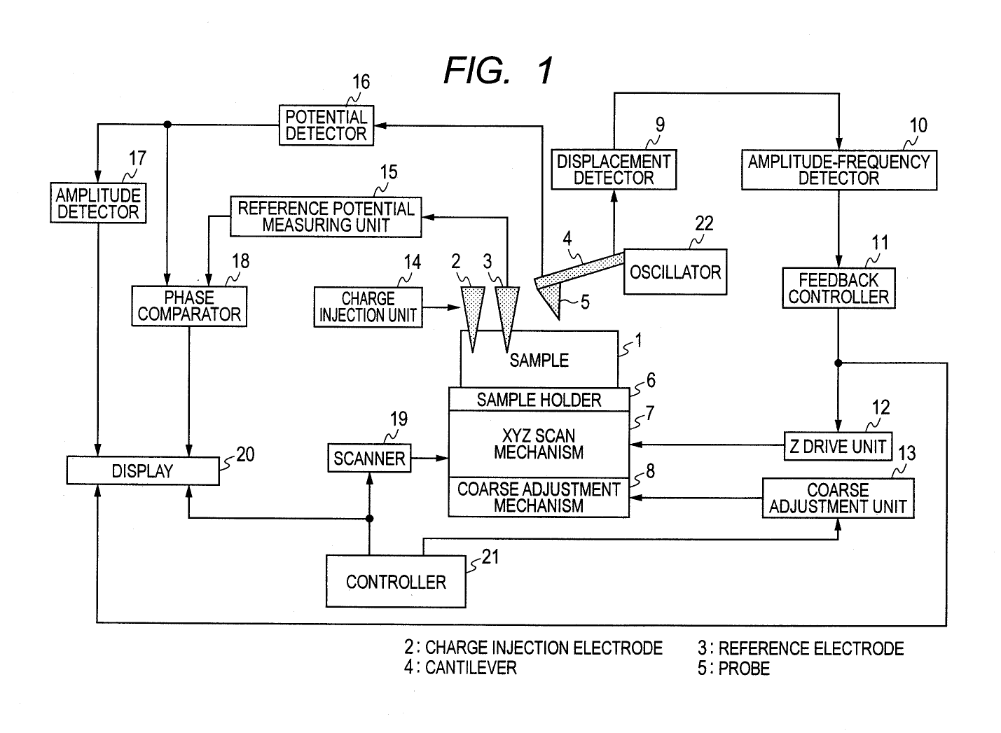

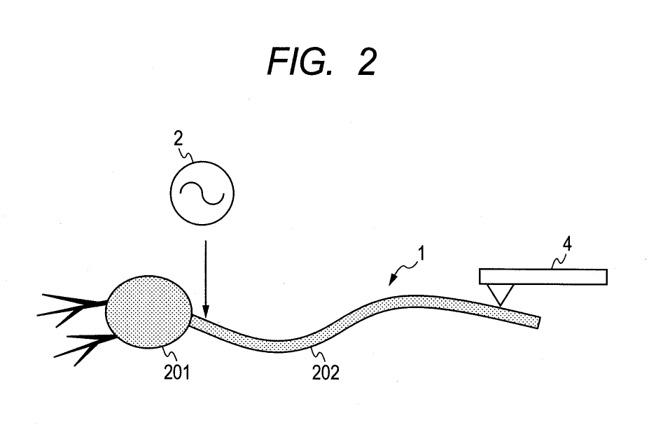

FIG. 1 is a block diagram of an embodiment of a neural activity measurement system used in the present invention. FIG. 2 is an example of the measurement of a neuron. A first embodiment of the present invention will be described with reference to FIGS. 1 and 2.

A test sample 1 is assumed to be a neuron. A cantilever 4 is disposed opposite the surface of the test sample 1. Then, a probe 5 is placed at the end of the cantilever.

The cantilever 4 and the probe 5 are connected to an oscillator 22, and are oscillated at a natural frequency or at a neighboring frequency in the vertical direction to the surface of the test sample 1. The operation of the oscillator 22 is controlled by a controller 21.

The test sample 1 is fixed on an XYZ scan mechanism 7 and a coarse adjustment mechanism 8 through a sample holder 6. The test sample 1 can be moved in the three-dimensional direction with respect to the probe 5 by the XYZ scan mechanism 7. Further, the distance between the test sample 1 and the probe 5 can be significantly changed by the coarse adjustment mechanism 8.

In the measurement, first the controller 21 drives the coarse adjustment mechanism 8 by a coarse adjustment unit 13 to move the surface of the test sample 1 close to the probe 5. When the test sample 1 and the probe 5 are sufficiently close to each other, the oscillation state of the cantilever 4 is changed due to the interaction with the surface of the test sample 1. At this time, the displacement of the cantilever 4 is detected by a displacement detector 9. Further, the oscillation amplitude or frequency of the cantilever 4 is detected by an amplitude-frequency detector 10.

A feedback controller 11 drives the XYZ scan mechanism 7 in the Z direction by a Z drive unit 12 so that the oscillation amplitude or frequency of the cantilever 4 is a fixed value set by the controller 21. In this way, the distance between the probe 5 and the surface of the test sample 1 is kept constant.

In this state, when the controller 21 scans the XYZ scan mechanism 7 in the XY surface by using a scanner 19, the XYZ scan mechanism 7 adjusts the position in the Z direction according to the surface shape of the test sample 1. In this way, the distance between the surface of the test sample 1 and the tip of the probe 5 is kept constant.

The measurement is performed with the distance between the surface of the test sample 1 and the tip of the probe 5 being kept constant. First, a predetermined charge is injected into the test sample 1 by a charge injection electrode 2 through a charge injector 14. Thus, a voltage is applied to the test sample 1 which is the neuron.

The voltage (about several to hundreds of mV) is applied to the test sample 1 from the charge injection electrode 2. Then, the reference potential is measured as reference data by a reference potential measuring unit 15 through a reference electrode 3 placed on the test sample 1. The particular reference potential is stored in a storage not shown.

When the voltage is applied to the test sample 1 which is the neuron through the charge injector 14, a pulsing current is generated. The metal probe 5 is brought into contact with, or close proximity to, a desired position of the test sample 1. Then, the displacement of the cantilever 4, which occurs due to the influence of the pulsing current flowing through the cantilever 4, is detected by the displacement detector 9 in time series.

From the detected displacement, it is possible to measure the current flowing at the point where the particular probe comes into contact or proximity with the test sample 1 in time series.

Such detection is performed at plural points on the test sample 1 in order to identify the location of a conduction defect. The process of identifying the defect location is as follows. The measured current is compared to the reference potential stored in the controller 21 or stored in the storage in advance by an arithmetic device independently present (not shown). When the difference between the particular current and the reference potential exceeds a predetermined value, it is determined to be defective. Here, the example of comparing the measured current to the reference potential. However, it is also possible to sequentially compare the measurement results at the measurement points where the current is measured sequentially.

Further, it goes without saying that the standard of the predetermined value can be arbitrarily set in an input unit, not shown, that is connected to the controller 21.

More specifically, the comparison method is performed by calculating the phase and amplitude for each of the measurement results by an amplitude detector 17 and a phase comparator 18 respectively, and comparing the obtained phase and amplitude to the result of the reference potential measuring unit 15.

The result of the comparison, or the location where a continuity defect exceeding the predetermined value is found, may be displayed on a display 20.

According to the measurement system and method described in this embodiment, it is possible not only to easily measure the neural activity but also to identify continuity defects at the cell level, allowing diagnosis of mental illness derived from neural activity as well as prediction of a future development of mental illness.

### Second Embodiment

In the first embodiment, preliminary observation is not included. However, the ability of recognizing the object to be observed and measured in advance is effective in the measurement. In addition, shape measurement should be used to automate the measurement.

Thus, a description will be given to the case in which a shape observation mode is included in the configuration shown in FIG. 1. Here, the same content as the first embodiment will be omitted.

First, the test sample 1 is placed on the sample holder 6. Then, the test sample 1 is moved very close to the cantilever 4 and the probe 5. At this time, the cantilever 4 is oscillated at a natural frequency or at a neighboring frequency in the vertical direction to the surface of the test sample 1. The operation of the oscillator 22 connected to the cantilever 4 is controlled by the controller 21.

In this state, the probe 5 scans the test sample 1 to detect the atomic force acting on the probe 5 and the test sample 1. At this time, the probe 5 and the surface of the test sample 1 are brought into contact or proximity by a very small force. The distance between the probe and the sample is feedback controlled so that the bending of the cantilever is constant. In this way, the arithmetic unit obtains the surface shape based on the detection information in the scan area.

The obtained surface shape is stored in the storage not shown, and is displayed by the controller 21 on the display 20.

Based on the displayed content, the user can set the location where the charge injection electrode 2 is provided, and can specify the scan range of the probe 5, the measurement positions, and the like, through the input unit.

There is a case in which the neuron does not appear in the surface shape. Hence, the shape can also be obtained by the following method.

Similarly to the first embodiment, a charge is injected through the charge injection electrode 2 to apply a predetermined voltage to the test sample 1. At this time, in the first embodiment, the continuity is measured at the predetermined measuring points. However, in the second embodiment, the cantilever 4 performs a two-dimensional scan in the X-Y direction while the height between the probe 5 and the test sample 1 is kept constant, to measure the interfacial potential distribution in a predetermined range.

It is known that the interfacial potential (contact potential difference) represents the difference between work functions. When two materials having different work functions, such as the probe 5 and the test sample 1, are brought into contact or close proximity with each other, the current flows to equalize the Fermi level on both sides. As a result, a potential difference occurs in the equivalent state. This difference corresponds to the difference between the work functions of the probe 5 and the test sample 1.

Thus, the probe 5 whose work function is known, and the test sample 1 whose work function is not known, are disposed opposite each other. In this state when the cantilever is oscillated by the oscillator, an alternating current flows. The work function of the test sample 1 can be determined by measuring the voltage of the alternating current flowing through the test sample 1.

Thus, it is possible to visualize the potential distribution in the predetermined range of the sample by two-dimensionally scanning the sample surface based on the method described above.

As described above, the visualization of the potential distribution allows identification of the structure of the neuron that does not appear on the surface.

In this embodiment, there are two methods of identifying the shape and structure of the neuron. However, it goes without saying that these methods can be individually incorporated into the configuration of the first embodiment as independent modes.

The neuron, which is the test sample used in the first and second embodiments, may be collected from an animal or may be a cultured cell. In the latter case, a sample of mucous is collected from a subject at home, and is transmitted to a culture factory by mail or other method. Then, the transmitted sample is cultured by cell culture technology in the factory. Further, it is possible that the collected sample may be cultured in a hospital or laboratory. It is also possible to form from embryonic stem cells that change into various types of cells such as iPS, ES, and MUSE cells.

In this case, the cells can be collected not only from an adult but also a subject immediately after birth as described in the related art. Further, it is also possible to collect from an embryo. These cells are cultured, and then the neural activity is analyzed. In this way, it is possible to provide early detection of diseases such as mental illness derived from neural activity.

What is claimed is:

1. A neural activity measurement system comprising:
a sample holder on which a neuron is placed;
an electrode for applying a voltage to a predetermined portion of the neuron;
a cantilever that is disposed opposite the sample holder and brought into contact or close proximity with the neuron;
a controller for controlling a voltage to be applied to the neuron at a predetermined time interval;
a displacement detector for detecting a current flowing through the neuron when the voltage is applied, by the displacement of the cantilever;
a storage for storing the time-series data of the current flowing through the neuron as reference information; and
an arithmetic unit comparing the detection result to the previously stored reference information for defect determination.

2. The neural activity measurement system according to claim 1,
wherein the arithmetic unit calculates the surface shape of the neuron obtained by the scan of the cantilever.

3. The neural activity measurement system according to claim 2,
wherein the scan of the cantilever is controlled by the controller.

4. The neural activity measurement system according to claim 2,
wherein the neural activity measurement system includes a display for displaying the surface shape.

5. The neural activity measurement system according to claim 1,
wherein the neural activity measurement system includes a reference electrode between the electrode and the cantilever,
wherein a current flowing through the neuron that is obtained by the reference electrode is stored in the storage as the reference information.

6. The neural activity measurement system according to claim 1,
wherein the cantilever is brought into contact or close proximity with the neuron sequentially, to obtain currents flowing in the range from the electrode to each of the points where the cantilever contacts or comes close to the neuron sequentially.

7. The neural activity measurement system according to claim 6,
wherein the arithmetic unit identifies the defect location by comparing the obtained result stored as the reference information, to each of the subsequently obtained results sequentially.

8. The neural activity measurement system according to claim 1,
wherein the reference information is the information stored in the storage in advance.

9. The neural activity measurement system according to claim 1,
wherein the neuron is a cultured cell.

10. A neural activity measurement method comprising:
applying a voltage to a neuron through an electrode;
causing a cantilever to contact or come close to the neuron sequentially;
obtaining the currents flowing in the range from the electrode to each of the points where the cantilever contacts or comes close to the neuron sequentially; and
identifying the defect location by comparing the obtained result to each of the subsequently obtained results.

11. A biological activity measurement method comprising:
collecting a sample from a subject;
culturing the collected sample to form a cell;
placing the cultured cell on a sample holder;
applying a voltage to a predetermined portion of the cell at a predetermined time interval;
causing a cantilever, which is disposed opposite the sample holder, to contact or come close to the cell;
detecting a current flowing through the cell when the voltage is applied, by the displacement of the cantilever;
storing the time-series data of the current flowing through the cell, in a storage as reference information; and
comparing the detected result to the reference information stored in the storage in advance for defect determination.
